(19) United States
(12) Patent Application Publication
(10) Pub. No.: US 2021/0241231 A1
(43) Pub. Date: Aug. 5, 2021

(54) Automatic Assignment of Tasks to Users in Collaborative Projects

(71) Applicant: RSA Security LLC, Bedford, MA (US)

(72) Inventors: Brian C. Mullins, Burlington, MA (US); Kevin D. Bowers, Melrose, MA (US); Victor Malchikov, Foster City, CA (US)

(21) Appl. No.: 16/778,142

(22) Filed: Jan. 31, 2020

(51) Int. Cl. G06Q 10/10; G06Q 10/06; G06F 40/30; G06N 20/00

(52) U.S. Cl. CPC G06Q 10/103; G06Q 10/063112; G06F 40/30; G06Q 10/063118; G06Q 10/105; G06Q 10/06398; G06N 20/00; G06Q 10/063114

(57) ABSTRACT

Techniques are provided for automatically assigning tasks of a collaborative project, such as questions within a risk assessment, to users. One method comprises obtaining a description of multiple tasks of a collaborative project; obtaining a first vector representation of a context of at least one of the tasks; obtaining a second vector representation of a context of at least one user; determining a similarity between one or more first vector representations and one or more second vector representations using one or more similarity criteria. The first and second vector representations may be obtained using natural language processing techniques, word embeddings that translate words into at least one vector, term frequency-inverse document frequency vectorization techniques, and/or a bag-of-words model.

### FIELD

The field relates generally to information processing techniques, and more particularly to processing collaborative projects.

### BACKGROUND

Collaborative projects comprised of multiple tasks allow teams to work together (and often independently on particular tasks) to complete a given project, often across departmental, corporate and geographic boundaries. Risk assessments, for example, allow companies to assess the risk posed by third party vendors and other potential business partners. Risk assessments typically comprise a significant number of questions and can take a considerable amount of time to complete. Risk assessments often involve a number of employees to complete the responses to the various questions.

A need exists for techniques for automatically assigning tasks of a collaborative project, such as questions within a risk assessment, to users.

### SUMMARY

In one embodiment, a method comprises obtaining a description of a plurality of tasks of a collaborative project; obtaining a first vector representation of a context of at least one of the plurality of tasks; obtaining a second vector representation of a context of at least one user; determining a similarity between one or more first vector representations and one or more second vector representations using one or more similarity criteria.

In some embodiments, the first vector representation of the context of each of the plurality of tasks and the second vector representation of the context of the at least one user are obtained using natural language processing techniques, word embeddings that translate one or more words into at least one vector, term frequency-inverse document frequency vectorization techniques, and/or a bag-of-words model.

In one or more embodiments, assignment of at least one task to at least one user employs machine learning techniques, text classification, at least one recommender system and/or a statistical analysis.

Other illustrative embodiments include, without limitation, apparatus, systems, methods and computer program products comprising processor-readable storage media.

### BRIEF DESCRIPTION OF THE DRAWINGS

FIG. 1 illustrates a collaborative project submission and completion platform, according to at least one embodiment of the disclosure;

FIG. 2 illustrates an exemplary implementation of the collaborative task assignment module of FIG. 1 in further detail, according to some embodiments;

FIGS. 3A through 3C illustrate an evaluation of cosine similarity between a number of exemplary vector pairs, according to an embodiment;

FIG. 4 illustrates an exemplary sample of A portion of a collaborative project description, where the collaborative project description is organized into sections, according to one or more embodiments of the disclosure;

FIG. 5 is a flow chart illustrating an exemplary implementation of a collaborative project task assignment process, according to one embodiment of the disclosure;

FIG. 6 illustrates an exemplary processing platform that may be used to implement at least a portion of one or more embodiments of the disclosure comprising a cloud infrastructure; and

FIG. 7 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for automatically assigning tasks of a collaborative project, such as questions within a risk assessment, to users.

In one or more embodiments, tasks within a collaborative project, such as questions within risk assessments, are automatically assigned to the users most able to provide timely and accurate completion of a given task. In some embodiments, machine learning techniques are employed to intelligently assign multiple tasks of a collaborative project, often without manual intervention. In this manner, the task assignment process is less burdensome to collaborative project administrators and expedites the completion of the overall collaborative project.

While a number of exemplary embodiments of the disclosure are presented in the context of the assignment of questions in risk assessments, the disclosed assessment techniques can be more generally applied to the assignment of tasks in collaborative projects comprised of multiple tasks, as would be apparent to a person of ordinary skill in the art, based on the present disclosure. Exemplary collaborative projects include, without limitation, questions of a risk assessment, development tasks for software development, and staffing tasks for staffing a software development team or another team. Staffing of multiple employees to build a team, for example, can be considered a collaborative project, or a task in a larger collaborative project to be completed by the team (or a portion thereof).

Risk assessments typically comprise a number of questions (e.g., tasks) and are often used by companies to assess the risk posed by third party vendors and other potential business partners. Thus, prior to establishing or modifying a business relationship, a risk assessment often helps one business to assess the risk that may be incurred by choosing the other business as a business partner. For example, a credit card company seeking a new vendor to produce credit cards on its behalf may need to understand the risk of working with a particular credit card producer. Risk assessments often seek to provide answers related to internal processes of a vendor, such as how a given vendor handles sensitive customer data.

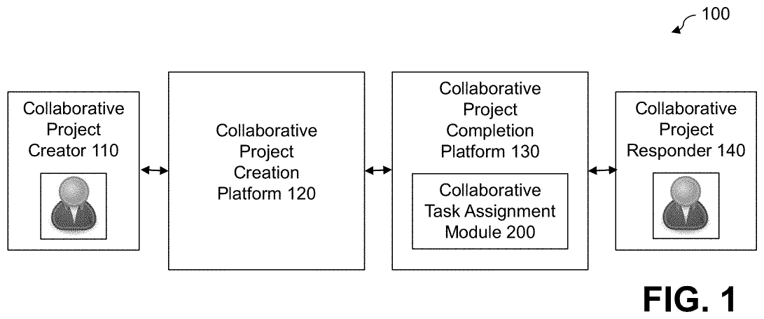

FIG. 1 illustrates a collaborative project submission and completion platform 100, according to at least one embodiment of the disclosure. As shown in FIG. 1, a collaborative project creator 110 submits one or more collaborative projects, optionally by means of a collaborative project creation platform 120, discussed further below. Tasks in the submitted collaborative project are to be completed by (and/or otherwise processed by) a collaborative project responder 140.

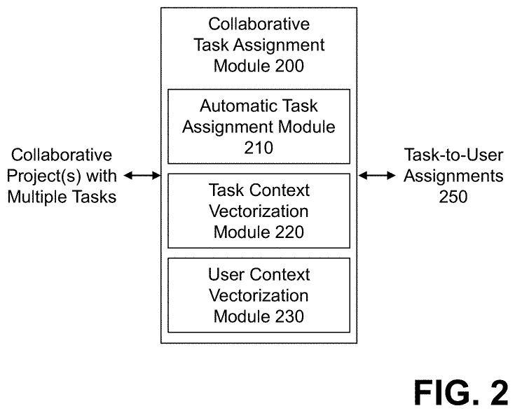

The collaborative project responder 140 responds to the collaborative project using a collaborative project completion platform 130. As shown in FIG. 1, the exemplary collaborative project completion platform 130 comprises a collaborative task assignment module 200, as discussed further below in conjunction with FIG. 2.

The collaborative project responder 140 may optionally delegate one or more tasks to another party or person, such as employees of the collaborative project responder 140 (collectively, referred to hereinafter as the collaborative project responder 140). In some embodiments, at least some of the tasks within a collaborative project are automatically assigned to users using the disclosed techniques. While only one instance is shown in FIG. 1 for each of the collaborative project creator 110 and the collaborative project responder 140, multiple instances of the collaborative project creator 110 and/or the collaborative project responder 140 can be present in various embodiments, as would be apparent to a person of ordinary skill in the art.

In some embodiments, the collaborative project creation platform 120 may be implemented using, for example, the RSA Archer® platform, commercially available from RSA Security LLC, of Dell EMC, Hopkinton, Mass. Generally, the exemplary RSA Archer® platform is an example of a Governance, Risk and Compliance (GRC) solution and allows vendors to complete risk assessments in a cloud-hosted portal. The collaborative project creation platform 120 may be hosted, for example, on the premises of the collaborative project creator 110 or in the cloud.

In some embodiments, the collaborative project completion platform 130 may be implemented using the techniques described herein for automatically assigning tasks of a collaborative project to users. The collaborative project completion platform 130 may be hosted, for example, on the premises of the collaborative project responder 140 or in the cloud.

In one or more embodiments, a collaborative project comprises multiple tasks. A collaborative project submitted by the collaborative project creator 110 comprises, for example, one or more of the following exemplary attributes for each task in the collaborative project:
ID: an identifier for each task;
Text: a textual description of each task; and
Tags: a set of key-value pairs describing each tag, such as category.

As noted above, the collaborative project creator 110 is an entity (e.g., an organization or individual) that submits a collaborative project (e.g., a questionnaire) to be completed by a designated collaborative project responder 140. The collaborative project creator 110 may be characterized in some embodiments, as follows:
ID: an identifier for the collaborative project creator 110; and
Tags: an arbitrary set of key-value pairs describing the collaborative project creator 110, such as a provider name and/or primary office location.

As noted above, the collaborative project responder 140 is an entity that responds to a collaborative project and may optionally delegate certain tasks to other entities, such as employees of the collaborative project responder 140. The collaborative project responder 140 may be characterized in one or more embodiments, as follows:
ID: an identifier for the collaborative project responder 140; and
Tags: an arbitrary set of key-value pairs describing the collaborative project responder 140.

The collaborative project creation platform 120 and collaborative project completion platform 130 in the FIG. 1 embodiment are assumed to be implemented using at least one processing device. Each such processing device generally comprises at least one processor and an associated memory, and implements one or more functional modules for controlling certain features of the collaborative project creation platform 120 and/or the collaborative project completion platform 130. More particularly, the collaborative project creation platform 120 and/or the collaborative project completion platform 130 in this embodiment comprises a processor coupled to a memory and a network interface (not shown in FIG. 1). The processor illustratively comprises a microprocessor, a microcontroller, an application-specific integrated circuit (ASIC), a field-programmable gate array (FPGA) or other type of processing circuitry, as well as portions or combinations of such circuitry elements. The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

A user of the collaborative project submission and completion platform 100 is, for example, an entity and/or person representing an organization using the collaborative project creation platform 120 (and/or the collaborative project completion platform 130). Also, it is to be appreciated that the term “user” in this context and elsewhere herein is intended to be broadly construed so as to encompass, for example, human, hardware, software or firmware entities, as well as various combinations of such entities.

A user of the collaborative project submission and completion platform 100 may access the collaborative project submission and completion platform 100, for example, using one or more user devices (not shown in FIG. 1). The user devices may comprise, for example, mobile telephones, laptop computers, tablet computers, desktop computers or other types of devices capable of supporting user access to network resources. Such devices are examples of what are more generally referred to herein as “processing devices.” Some of these processing devices are also generally referred to herein as “computers.” The user devices in some embodiments comprise respective computers associated with a particular company, organization or other enterprise.

The collaborative project creation platform 120 and the collaborative project completion platform 130 communicate, for example, over a computer network and/or a secure link. In some embodiments, a publish/subscribe mechanism can be used to communicate risk assessments to one or more collaborative project responders 140, and for the collaborative project creator 110 to receive responses to submitted risk assessments.

At least portions of the computer network may comprise an “enterprise network.” Numerous other operating scenarios involving a wide variety of different types and arrangements of processing devices and networks are possible, as will be appreciated by those skilled in the art. The computer network is assumed to comprise a portion of a global computer network such as the Internet, although other types of networks can be part of the computer network, including a wide area network (WAN), a local area network (LAN), a satellite network, a telephone or cable network, a cellular network, a wireless network such as a WiFi or WiMAX network, or various portions or combinations of these and other types of networks. The computer network in some embodiments therefore comprises combinations of multiple different types of networks each comprising processing devices configured to communicate using IP or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

The computer network may also include one or more storage devices. The storage device can be implemented, for example, using one or more storage systems. Such storage systems can comprise any of a variety of different types of storage including network-attached storage (NAS), storage area networks (SANs), direct-attached storage (DAS) and distributed DAS, as well as combinations of these and other storage types, including software-defined storage.

Examples of particular types of storage products that can be used in implementing a given storage system in an illustrative embodiment include VNX® and Symmetrix VMAX® storage arrays, software-defined storage products such as ScaleIO™ and ViPR®, flash-based storage arrays such as DSSD™, cloud storage products such as Elastic Cloud Storage (ECS), object-based storage products such as Atmos®, scale-out all-flash storage arrays such as XtremIO™, and scale-out NAS clusters comprising Isilon® platform nodes and associated accelerators in the S-Series, X-Series and NL-Series product lines, all from EMC Corporation of Hopkinton, Mass. Combinations of multiple ones of these and other storage products can also be used in implementing a given storage system in an illustrative embodiment.

The storage device can illustratively comprise a single storage array, storage disk, storage drive or other type of storage device. Alternatively, the storage device can comprise one or more storage systems each having multiple storage devices implemented therein. The term “storage device” as used herein is therefore intended to be broadly construed. In some embodiments, a storage device may comprise a network share or possibly even an attached device such as a USB stick. Accordingly, in some embodiments, the storage device may be attached to one or more user devices in addition to or in place of being attached to the computer network. The stored files on the storage device may be encrypted using an encryption process implemented by the user to protect the stored files from unauthorized access.

One or more aspects of the disclosure recognize that it is unlikely that a single person can complete all tasks within a given collaborative project and typically requires input from several people. While the assignment of users to tasks is traditionally done manually, there is an opportunity to improve the task assignment process by automating the assignment. One challenge arises in determining, for each task, who is the best person to complete a given task. The measure of “best” can include many aspects, but one important factor is knowledge (as well as, for example, other skills and/or capabilities of the user). For example, the assignment process may consider whether the assigned user can complete the given task (e.g., does the user know the answer to the question being asked), or does that person need to delegate the task to another person or entity (e.g., research the answer). In an ideal solution, the assignment of users to questions would be done once and each user would be able to quickly and easily answer all questions assigned to them.

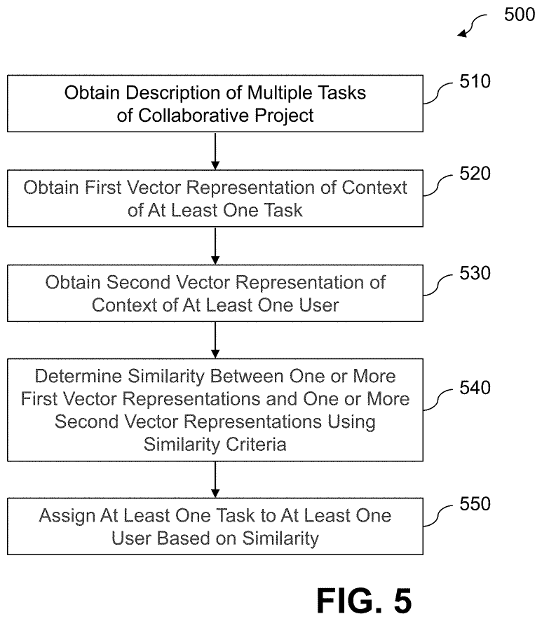

FIG. 2 illustrates an exemplary implementation of the collaborative task assignment module 200 of FIG. 1 in further detail, according to some embodiments of the disclosure. As shown in FIG. 2, the exemplary collaborative task assignment module 200 processes one or more collaborative projects with multiple tasks and generates a set of task-to-user assignments 250, for example, using the techniques discussed further below in conjunction with FIG. 5. The exemplary collaborative task assignment module 200 comprises an automatic task assignment module 210, a task context vectorization module 220 and a user context vectorization module 230, each discussed further below.

In some embodiments, the exemplary automatic task assignment module 210 employs machine learning techniques, recommender systems, text classification and/or statistical analysis techniques (e.g., computations such as cosine similarity) that leverage context to learn which users are most likely to best complete a given task (e.g., answer a particular type of question) and then leverage those learned relationships to do automated task assignment going forward.

There are several sources of context that can be used to build these relationships, as discussed further below in conjunction with the section entitled “Context Sources.” One source of context is the text of the task itself. If task descriptions were always written in the same way, a mapping could be learned directly from task text to the users that are most likely assigned to complete the task. Natural Language Processing (NLP) techniques can be leveraged, for example, in some embodiments, to capture and compare the meaning of the text. In other embodiments described herein, the meaning of the task text can also be evaluated using word embeddings that translate words into a vector, term frequency-inverse document frequency vectorization techniques, and/or a bag-of-words model.

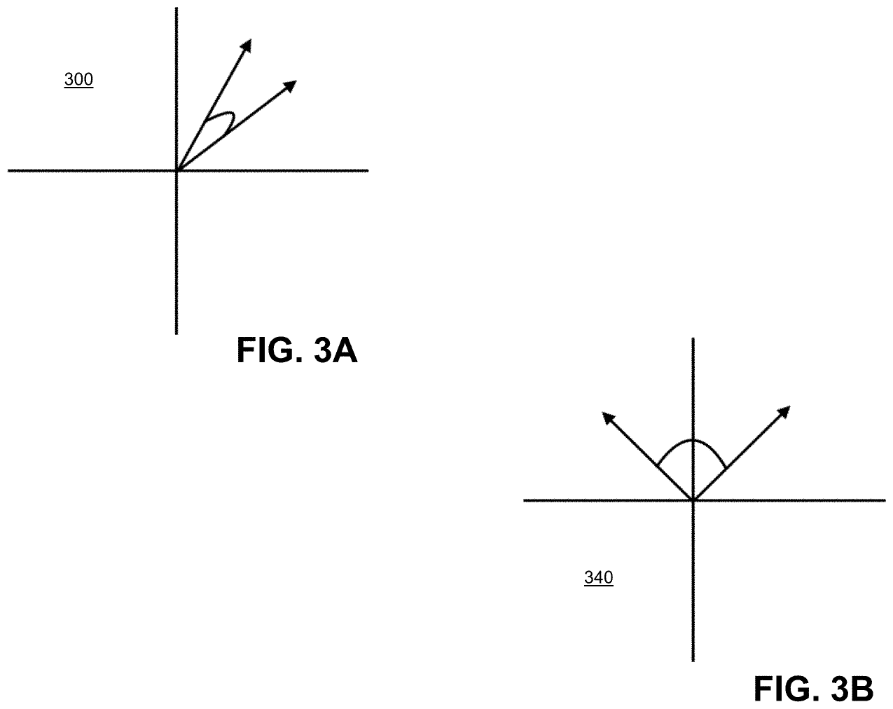

The exemplary task context vectorization module 220 can employ one or more techniques to determine the context of tasks within a given collaborative project and otherwise aid in the determination of the meaning of the text, so that the text representation can be captured and compared. In one exemplary implementation, the exemplary task context vectorization module 220 leverages word embeddings that translate words into vectors. Words with similar meanings will have similar vectors, while unrelated words will have very different vectors. Each word in the task text can be converted to a vector (e.g., after stop words are removed) and the vectors can be averaged to create a vector representation for a given task. To compare similarity between questions, for example, another question will be embedded by the exemplary task context vectorization module 220 in the same (or substantially similar) way and a cosine similarity between resulting vectors will be computed, as discussed further below in conjunction with FIGS. 3A through 3C.

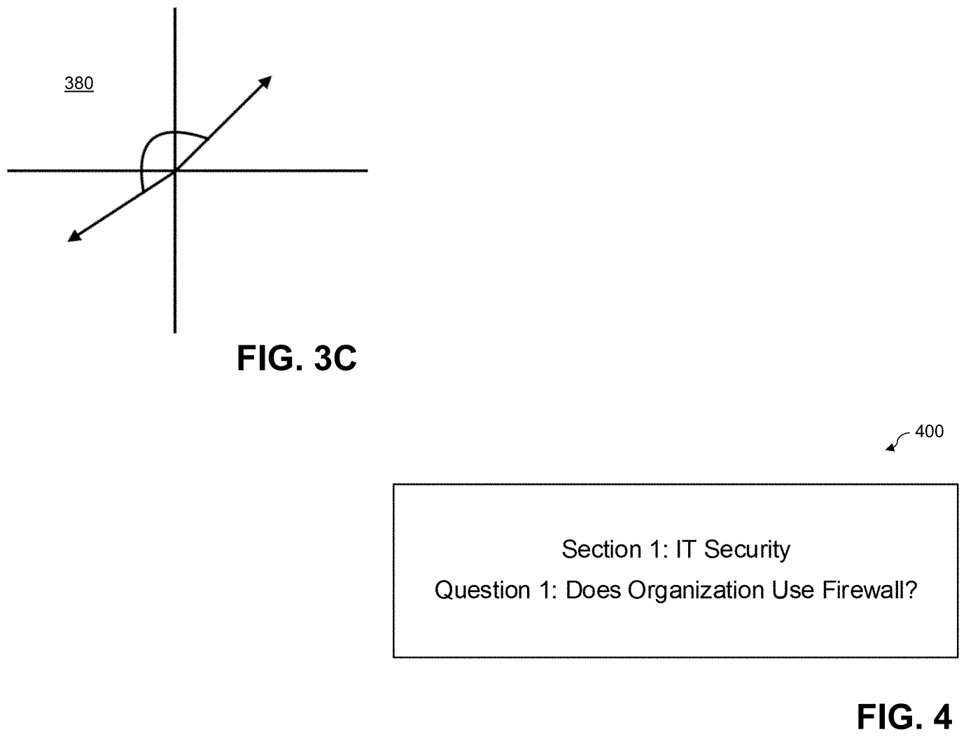

In some embodiments, the exemplary task context vectorization module 220 may optionally evaluate additional context, when available, to improve the translation of words into vectors. For example, collaborative project descriptions are often organized into sections, as discussed further below in conjunction with FIG. 4, and the names of the sections can also be leveraged by pre-pending the section title to the task text before performing an embedding, as would be apparent to a person of ordinary skill in the art, based on the present disclosure.

The exemplary user context vectorization module 230 can employ one or more techniques and/or data sources to determine the context of a given user. For example, the context of a given user may be obtained from one or more of, for example: (i) a knowledge of the given user, (ii) skills of the given user, (iii) credentials of the given user, (iv) a social media profile of the given user, (v) a resume of the given user, (vi) a biography of the given user, (vii) an employment history of the given user, (viii) an education history of the given user, and (ix) a job title of the given user.

One or more aspects of the disclosure recognize that tasks with high similarity in the vector space will be related to very similar tasks, so the users assigned to the first task can likely be assigned to the second task as well. With enough training examples of tasks to which a user is assigned, the exemplary user context vectorization module 230 can create clusters of user knowledge (or other skills and/or capabilities of the user) in the embedded space. These clusters could then be used directly by computing the embedding of a task and determining which user has the closest cluster in the embedded space and recommending that user (or set of users) complete the task. In addition, the user context vectorization module 230 can determine the context of one or more of the users from one or more clusters of similar users.

FIGS. 3A through 3C illustrate an evaluation of cosine similarity between a number of exemplary vector pairs 300, 340, 380, respectively, according to an embodiment. FIG. 3A illustrates an exemplary vector pair 300 corresponding to substantially similar vectors, where the cosine of the angle between the exemplary vector pair 300 is close to 0 degrees. FIG. 3B illustrates an exemplary vector pair 340 corresponding to substantially orthogonal vectors, where the cosine of the angle between the exemplary vector pair 340 is close to 90 degrees. Finally, FIG. 3C illustrates an exemplary vector pair 380 corresponding to substantially opposite vectors, where the cosine of the angle between the exemplary vector pair 380 is close to 180 degrees.

FIG. 4 illustrates an exemplary sample 400 of a collaborative project description, for a risk assessment implementation, where the collaborative project description is organized into sections, according to one or more embodiments of the disclosure. As noted above, in some embodiments, the exemplary task context vectorization module 220 evaluates additional context, such as additional text in a collaborative project description, when available, to improve the translation of words into vectors. In the example of FIG. 4, the collaborative project comprises a risk assessment, and the risk assessment descriptions are organized into sections and the names of the sections, such as a section for IT Security (section (1)) (or other structured document portions of a collaborative project description can also be leveraged), are optionally leveraged by pre-pending the section title to the question text before the task context vectorization module 220 of FIG. 2 performs an embedding, as would be apparent to a person of ordinary skill in the art, based on the present disclosure.

Automatic Task Assignment for New Users

The above-described approach for the automatic task assignment module 210 of FIG. 2 processes a training set of mappings from users to tasks as a learning phase for the machine learning models, for example. In some embodiments, techniques are also provided to address a new user who has never been assigned tasks.

In some embodiments, users can be mapped to tasks without a human-driven training input dataset by measuring a similarity between context about what the user knows (or other skills and/or capabilities of the user) and the task to be completed. As noted above, the context of a given user can be obtained from, for example, one or more of: (i) a knowledge of the given user, (ii) skills of the given user, (iii) one or more credentials of the given user, (iv) a social media profile of the given user, (v) a resume of the given user, (vi) a biography of the given user, (vii) an employment history of the given user, (viii) an education history of the given user, and (ix) a job title of the given user (collectively, referred to herein as capabilities of a user). The context of the given user can then be embedded into a vector space by the user context vectorization module 230 and the similarity between the vector of the task (generated, for example, by the task context vectorization module 220 of FIG. 2) and the vector representing the user context (generated, for example, by the user context vectorization module 230 of FIG. 2) can be compared. When the similarity is high, that user could be recommended to complete a given task. The collaborative project submission and completion platform 100 would then observe when recommendations for task-to-user assignments 250 are accepted, when they are changed, and importantly, which user completes each task to start to build the necessary training data required for the training method described above.

Automatic Task Assignment: Alternate Matching Methods

While one or more techniques described above leverage word embeddings, other techniques could be used as well to compare similarity between a task and a context of a user, such as knowledge or other capabilities. For example, as noted above, a similarity between a task and a context of a user can also (or alternatively) be performed using term frequency-inverse document frequency vectorization techniques, and/or a bag-of-words model. Once text is vectorized and made comparable, techniques such as text classification can also be leveraged. Text classification assigns a set of tags to text from a predefined set. Text classification applies tags to the text, which are initially human-generated. Thus, the matching of users to tasks based on shared tags can be explained (even if the selection of tags for each text is hard to explain).

As noted above, the vector representations of the context of each of the tasks and/or the context of the users are obtained using NLP techniques, word embeddings that translate words into vectors, term frequency-inverse document frequency vectorization techniques, and/or a bag-of-words model. The choice of which of the above techniques to use depends, for example, the specifics of the use case. One or more aspects of the disclosure recognize that for some implementations, NLP techniques allow a comparison of the similarity of text and the similarity measurements can be leveraged to perform automated recommendation or assignment of tasks to users by the automatic task assignment module 210. The text being compared needs to reflect the things that are being matched (e.g., the capabilities of a user and the task being completed). The source of this data is described in more detail below.

Representative Context Sources

There are many sources of contextual knowledge that can be leveraged for making task assignment predictions. For example, the context sources may include, without limitation, one or more of the following representative context sources:

User Profile

As noted above, user profile data can be used to provide information about expertise and/or other capabilities of a user. For example, for an exemplary implementation using the RSA Archer® platform, referenced above, profile data can be extracted from the user profile on the platform (or another platform). Additional data could be sourced from other places such as an organization chart of the vendor or social media sources, such as LinkedIn. Data that could help influence matching includes, but is not limited to:
current/previous title;
current/previous department;
education credentials (e.g., degree); and
professional certifications.

Since user expertise and capabilities typically evolve over time, these sources of data can optionally be checked for updates. The number of years a user has been in a particular industry/department/role, for example, could be used in some embodiments as a weighting factor.

Historical Analysis

As noted above, context information can also be obtained by tracking previous tasks that a user completed, or otherwise interacted with. Representative data that could help influence the matching process includes, without limitation:
previously assigned sections;
previously assigned tasks;
tasks that the user never completed;
tasks that the user assigned/unassigned to themselves;
tasks that the user completed (especially, if not assigned to the user); and
a time to complete a given task.

Capacity Planning

One problem that may arise when automating task assignment is that a matching solution may not always assign tasks to the best match, since a potentially assigned user has a finite capacity for how many tasks that the user can complete in a timely manner. Thus, in some embodiments, the following data may also be considered among possible matches:
user velocity, where velocity, v, is defined as the number of tasks a user can complete in a given time window (e.g., a number of questions per week);
changes in user velocity over time (e.g., do users slow down at end-of-quarter);
a number of outstanding tasks (e.g., tasks that are assigned to a given user but not completed);
a number of outstanding questions for a risk assessment implementation (e.g., questions that are assigned and still unanswered);
an average duration of the given user to complete a given task (e.g., if telemetry data was tracked for how long tasks typically take to complete, the telemetry data could be used to match against a user's capacity (e.g., a number of hours available to work on completing tasks), instead of merely tracking the number of outstanding assessments;
deadlines for outstanding tasks; and
an availability of users (e.g., tracking user vacation time or other indications of when a user out-of-office or otherwise unavailable for an extended period of time)

The capacity planning limitation on task assignments could be implemented in some embodiments by considering a set of users when matching a task. For the N best possible matches, as calculated using the NLP techniques described above, for example, one or more of the above-listed capacity metrics can be considered by aggregating them into a weighting function, and then upon applying the weighting function, the user that is the best overall match can be selected.

By tracking clusters of users who complete assessments together, automated capacity planning techniques could be employed to identify users that should be targeted for an assignment. Additionally, if an organization chart was made available, programmatic discovery of similar users could be done to target users for an assignment.

Portal User Experience: Surfacing Recommended Users

In some embodiments, a user portal of the collaborative project submission and completion platform 100 (or a portion thereof) provides functionality to automatically allow a given user assigned to a given task to delegate the given task to another user and/or to automatically request assistance from another user to complete the given task. In addition, the user portal of the collaborative project submission and completion platform 100 can present clusters of users and make suggestions if the typical group of users are not all represented. For example, consider that users Bob and Alice typically complete assessments together. If only Alice is assigned to a task assignment, upon logging in, Alice could be shown a recommendation to invite Bob to join her in completing the assessment.

In further variations, the user portal of the collaborative project submission and completion platform 100 can also, or alternatively, present data indicative of one or more of the capacity planning factors described above. For example, a user's capacity to complete tasks can be presented which can enable a user with a choice of inviting either Bob or Alice to complete an assessment; when viewing their respective capacity information, can select the person that is most likely to complete the task.

As noted above, while one or more exemplary embodiments are directed to an assignment of questions from a risk assessment to users, the disclosed assignment techniques can be applied to any collaborative project for the assignment of users to complete tasks of the collaborative project. Exemplary collaborative projects include, without limitation, questions of a risk assessment, development tasks for software development, and staffing tasks for staffing a software development team or another team.

In the context of software development, for example, each software developer typically has specialized skills and Scrum user stories can be used, for example, to describe needed functionality. Generally, a user story is a high-level definition of a requirement, containing basic information so that developers can generate estimates of the effort required to implement the requirement. One or more aspects of the disclosure recognize that matching developer skills to needed development tasks, while optionally accounting for load and other factors, would be beneficial to software engineering organizations trying to optimize or otherwise complete development.

Staffing of multiple employees to build a team, for example, can also be considered a collaborative project, or a task in a larger collaborative project to be completed by the team (or a portion thereof). If the goals or needs of a team could be documented, then the disclosed techniques can be employed to evaluate individual skills (e.g., by parsing a resume or performance statistics to determine the capabilities of a potential team member) for suitability within a given team with a shared goal.

FIG. 5 is a flow chart illustrating an exemplary implementation of a collaborative project task assignment process 500, according to one embodiment of the disclosure. As shown in FIG. 5, the exemplary collaborative project task assignment process 500 initially obtains a description of multiple tasks of a collaborative project during step 510. During step 520, the exemplary collaborative project task assignment process 500 obtains a first vector representation of a context of at least one task. During step 530, the exemplary collaborative project task assignment process 500 obtains a second vector representation of a context of at least one user.

The exemplary collaborative project task assignment process 500 then determines a similarity between one or more first vector representations and one or more second vector representations during step 540 using similarity criteria. For example, a cluster can be denoted by an average vector of all users in the cluster (thus, the representation is also a vector). Thus, the vector representation can be directly compared to the first vector representation of the context of each task. Finally, the at least one task is assigned to the at least one user based on the similarity during step 550.

The particular processing operations and other functionality described in conjunction with the flow diagram of FIG. 5 are presented by way of illustrative example only, and should not be construed as limiting the scope of the disclosure in any way. Alternative embodiments can use other types of processing operations to automatically assign tasks of a collaborative project to users. For example, the ordering of the process steps may be varied in other embodiments, or certain steps may be omitted, or performed concurrently with one another rather than serially. In some aspects, additional actions can be performed.

In one or more embodiments, techniques are provided to automatically assign users to tasks of a given collaborative project to improve correctness, turn-around time, and overall user experience for completing tasks and the overall collaborative project.

In some embodiments, the disclosed techniques for automatically assigning tasks of a collaborative project to users allow an organization to assign users to tasks more effectively and in a more informed manner.

One or more embodiments of the disclosure provide improved methods, apparatus and computer program products for automatically assigning tasks of a collaborative project, such as questions within a risk assessment, to users. The foregoing applications and associated embodiments should be considered as illustrative only, and numerous other embodiments can be configured using the techniques disclosed herein, in a wide variety of different applications.

It should also be understood that the disclosed collaborative project task assignment techniques, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for automatically assigning tasks of a collaborative project to users may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a Platform-as-a-Service (PaaS) offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based collaborative project task assignment engine, or portions thereof, are illustratively implemented for use by tenants of such a multi-tenant environment.

Cloud infrastructure as disclosed herein can include cloud-based systems such as Amazon Web Services (AWS), Google Cloud Platform (GCP) and Microsoft Azure. Virtual machines provided in such systems can be used to implement at least portions of a cloud-based collaborative project task assignment platform in illustrative embodiments. The cloud-based systems can include object stores such as Amazon S3, GCP Cloud Storage, and Microsoft Azure Blob Storage.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

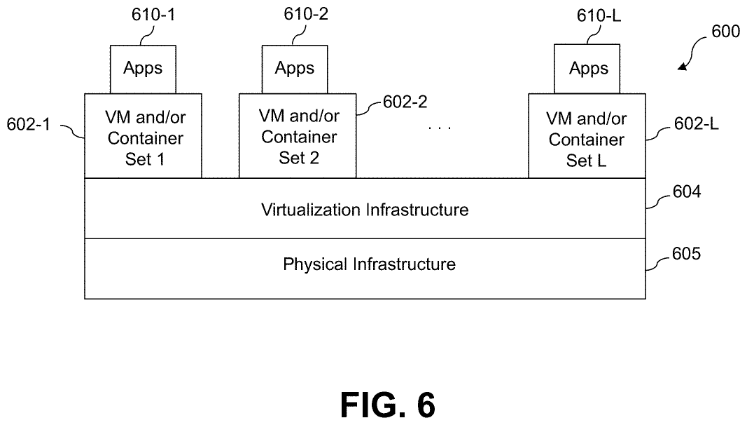

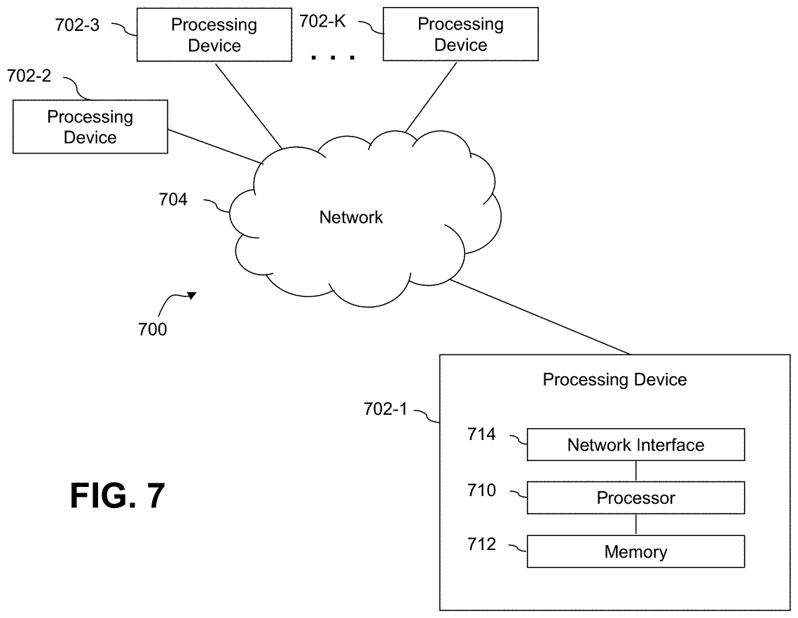

Illustrative embodiments of processing platforms will now be described in greater detail with reference to FIGS. 6 and 7. These platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of an information processing system. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. Such implementations can provide collaborative project task assignment functionality of the type described above for one or more processes running on a given one of the VMs. For example, each of the VMs can implement project task assignment control logic and associated vector comparison techniques for providing project task assignment functionality for one or more processes running on that particular VM.

An example of a hypervisor platform that may be used to implement a hypervisor within the virtualization infrastructure 604 is the VMware® vSphere® which may have an associated virtual infrastructure management system such as the VMware® vCenter™. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system. Such implementations can provide project task assignment functionality of the type described above for one or more processes running on different ones of the containers. For example, a container host device supporting multiple containers of one or more container sets can implement one or more instances of project task assignment control logic and associated vector comparison techniques for use in collaborative project task assignment.

As is apparent from the above, one or more of the processing modules or other components of the collaborative project submission and completion platform 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises at least a portion of the given system and includes a plurality of processing devices, denoted 702-1, 702-2, 702-3, . . . 702-K, which communicate with one another over a network 704. The network 704 may comprise any type of network, such as a WAN, a LAN, a satellite network, a telephone or cable network, a cellular network, a wireless network such as WiFi or WiMAX, or various portions or combinations of these and other types of networks.

The processing device 702-1 in the processing platform 700 comprises a processor 710 coupled to a memory 712. The processor 710 may comprise a microprocessor, a microcontroller, an ASIC, a FPGA or other type of processing circuitry, as well as portions or combinations of such circuitry elements, and the memory 712, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 6 or 7, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure such as VxRail™, VxRack™, VxBlock™, or Vblock® converged infrastructure commercially available from Dell EMC.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining a description of a plurality of tasks of a collaborative project;
obtaining a first vector representation of a context of at least one of the plurality of tasks;
obtaining a second vector representation of a context of at least one user;
determining a similarity between one or more first vector representations and one or more second vector representations using one or more similarity criteria; and
assigning the at least one task to the at least one user based at least in part on the similarity,
wherein the method is performed by at least one processing device comprising a processor coupled to a memory.

2. The method of claim 1, wherein the first vector representation of the context of each of the plurality of tasks and the second vector representation of the context of the at least one user are obtained using one or more of natural language processing techniques, word embeddings that translate one or more words into at least one vector, term frequency-inverse document frequency vectorization techniques, and a bag-of-words model.

3. The method of claim 1, wherein the context of a given task of the plurality of tasks is obtained from one or more of the description of the given task and additional text in the collaborative project.

4. The method of claim 1, wherein the context of a given user of the at least one user is obtained from one or more of: (i) a knowledge of the given user, (ii) one or more skills of the given user, (iii) one or more credentials of the given user, (iv) a social media profile of the given user, (v) a resume of the given user, (vi) a biography of the given user, (vii) an employment history of the given user, (viii) an education history of the given user, and (ix) a job title of the given user.

5. The method of claim 1, wherein the context of a given user of the at least one user is obtained from one or more of: (i) previously assigned portions of a collaborative project, (ii) previously assigned tasks of a collaborative project, (iii) previously assigned tasks of a collaborative project that remain incomplete, (iv) voluntary assignment or removal from previously assigned tasks of a collaborative project, (v) previously assigned tasks of a collaborative project completed by the given user, and (vi) a time to complete a previously assigned task.

6. The method of claim 1, wherein the context of the at least one user is obtained from one or more clusters of similar users.

7. The method of claim 1, wherein the assigning to the at least one user employs one or more of machine learning techniques, text classification, at least one recommender system and a statistical analysis.

8. The method of claim 1, wherein the assigning to the at least one of the at least one user is further based at least in part on one or more of a user velocity indicating a number of tasks that a given user of the at least one user can process in a time window, a change in the user velocity of the given user over time, a number of outstanding tasks of the given user, an average duration of the given user to complete a given task, a deadline for a given task, and an availability of one or more of the at least one user.

9. The method of claim 1, wherein a given user assigned to a given task can one or more of delegate the given task to at least one other user and automatically request assistance from at least one other user to complete the given task.

10. The method of claim 9, wherein the given user is notified of one or more of an availability and a capacity of the at least one other user.

11. An apparatus comprising:
at least one processing device comprising a processor coupled to a memory;
the at least one processing device being configured to implement the following steps:
obtaining a description of a plurality of tasks of a collaborative project;
obtaining a first vector representation of a context of at least one of the plurality of tasks;
obtaining a second vector representation of a context of at least one user;
determining a similarity between one or more first vector representations and one or more second vector representations using one or more similarity criteria; and
assigning the at least one task to the at least one user based at least in part on the similarity.

12. The apparatus of claim 11, wherein the first vector representation of the context of each of the plurality of tasks and the second vector representation of the context of the at least one user are obtained using one or more of natural language processing techniques, word embeddings that translate one or more words into at least one vector, term frequency-inverse document frequency vectorization techniques, and a bag-of-words model.

13. The apparatus of claim 11, wherein the context of the at least one user is obtained from one or more clusters of similar users.

14. The apparatus of claim 11, wherein the assigning to the at least one of the at least one user employs one or more of machine learning techniques, text classification, at least one recommender system and a statistical analysis.

15. The apparatus of claim 11, wherein a given user assigned to a given task can one or more of delegate the given task to at least one other user and automatically request assistance from at least one other user to complete the given task.

16. A non-transitory processor-readable storage medium having stored therein program code of one or more software programs, wherein the program code when executed by at least one processing device causes the at least one processing device to perform the following steps:
obtaining a description of a plurality of tasks of a collaborative project;
obtaining a first vector representation of a context of at least one of the plurality of tasks;
obtaining a second vector representation of a context of at least one user;
determining a similarity between one or more first vector representations and one or more second vector representations using one or more similarity criteria; and
assigning the at least one task to the at least one user based at least in part on the similarity.

17. The non-transitory processor-readable storage medium of claim 16, wherein the first vector representation of the context of each of the plurality of tasks and the second vector representation of the context of the at least one user are obtained using one or more of natural language processing techniques, word embeddings that translate one or more words into at least one vector, term frequency-inverse document frequency vectorization techniques, and a bag-of-words model.

18. The non-transitory processor-readable storage medium of claim 16, wherein the context of the at least one user is obtained from one or more clusters of similar users.

19. The non-transitory processor-readable storage medium of claim 16, wherein the assigning to the at least one of the at least one user employs one or more of machine learning techniques, text classification, at least one recommender system and a statistical analysis.

20. The non-transitory processor-readable storage medium of claim 16, wherein a given user assigned to a given task can one or more of delegate the given task to at least one other user and automatically request assistance from at least one other user to complete the given task.
